(19) United States
(12) Patent Application Publication
(10) Pub. No.: US 2025/0220141 A1
(43) Pub. Date: Jul. 3, 2025

(54) LENS MODULE, PROJECTION DEVICE, AND FOCUSING METHOD OF PROJECTION DEVICE

(71) Applicant: Coretronic Corporation, Hsin-Chu (TW)

(72) Inventors: Chi-Wen Ke, Hsin-Chu (TW); Chun-Yi Lee, Hsin-Chu (TW); Hung-Wei Lin, Hsin-Chu (TW)

(73) Assignee: Coretronic Corporation, Hsin-Chu (TW)

(21) Appl. No.: 18/983,384

(22) Filed: Dec. 17, 2024

(30) Foreign Application Priority Data
Jan. 2, 2024 (CN) 202410002011.7

(51) Int. Cl. H04N 9/31

(52) U.S. Cl. CPC H04N 9/317; H04N 9/3194

(57) ABSTRACT

Disclosed is a lens module adaptable for a projection device. The controller is configured to: control the drive module to drive the rotary adjustment member to rotate in a first direction, so that the gravity sensor rotates with the rotary adjustment member from a starting position and stops at a first position to obtain a first rotary angle value; control the drive module to drive the rotary adjustment member to rotate in a second direction, so that the gravity sensor rotates with the rotary adjustment member from the first position and stops at a second position to obtain a second rotary angle value; and adjust a focal length of the projection lens according to the first rotary angle value and the second rotary angle value. The projection device and a focusing method of the projection device are also provided.

### CROSS-REFERENCE TO RELATED APPLICATION

This application claims the priority benefit of China application serial no. 202410002011.7, filed on Jan. 2, 2024. The entirety of the above-mentioned patent application is hereby incorporated by reference herein and made a part of this specification.

### BACKGROUND

### Technical Field

The disclosure relates to a lens module, a projection device, and a focusing method of the projection device.

### Description of Related Art

When a projector uses autofocusing or electric focusing, a processor of the projector controls the movement of the lens module of the projector by a feedback mechanism of a lens displacement sensing system to achieve a clear focusing effect.

In the related art, two sets of gravity sensors are used in a sensing method of using gravity sensors and are placed on the moving members and the non-moving members of the lens module respectively. Because the three vector variables of the XYZ shaft of the gravity sensors are used to calculate an angle, the two sets of the gravity sensors can sense six vector variables and are provided to the processor to calculate the displacement direction and amount.

However, in the aforementioned lens displacement sensing system, the use of at least two sets of the gravity sensors may cause a problem that the sensing module is large in size, and the large number of vector variables may cause problems of the complicated calculation and the amount of calculation during the calculation process of the processor.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a lens module, a projection device using the lens module, and a focusing method of the projection device, which can reduce the size of the lens module and calculate the displacement direction and amount faster.

Other objects and advantages of the disclosure may be further understood from the technical features disclosed in the disclosure.

In order to achieve one, part or all of the above objects or other objects, an embodiment of the disclosure provides a lens module, adaptable for a projection device. The lens module includes a projection lens, a rotary adjustment member, a gravity sensor, a drive module, and a controller. The rotary adjustment member is connected to the projection lens and is adapted to be rotated to adjust a focal length of the projection lens. The gravity sensor is disposed on the rotary adjustment member, is adapted to rotate synchronously with the rotary adjustment member, and is configured to provide a sensing signal corresponding to the rotary adjustment member. The controller is electrically connected to the drive module and the gravity sensor and is configured to control the drive module and receive the sensing signal from the gravity sensor. The drive module is connected to the rotary adjustment member. The drive module is adapted to drive the rotary adjustment member to rotate under a control of the controller. The controller calculates a rotary angle value of the gravity sensor according to the sensing signal of the gravity sensor. The rotary angle value includes a first rotary angle value and a second rotary angle value. The controller is configured to: control the drive module to drive the rotary adjustment member to rotate in a first direction, so that the gravity sensor rotates with the rotary adjustment member from a starting position and stops at a first position; receive the sensing signal of the gravity sensor which is rotated from the starting position to the first position to obtain the first rotary angle value; control the drive module to drive the rotary adjustment member to rotate in a second direction, so that the gravity sensor rotates with the rotary adjustment member from the first position and stops at a second position, where the first direction is opposite to the second direction; receive the sensing signal of the gravity sensor which is rotated from the first position to the second position to obtain the second rotary angle value; obtain a maximum rotary range of the rotary adjustment member according to the first rotary angle value and the second rotary angle value and obtain a time required for the gravity sensor to rotate for a preset angle value when the drive module drives the rotary adjustment member; and adjust the focal length of the projection lens according to the maximum rotary range and the time required for the gravity sensor to rotate for the preset angle value.

In order to achieve one, part or all of the above objects or other objects, an embodiment of the disclosure provides a projection device. The projection device includes an illumination system, a light valve, and the aforementioned lens module, where the illumination system is configured to provide an illumination beam, the light valve is disposed on a transmission path of the illumination beam, and is configured to convert the illumination beam into an image beam, and the projection lens of the lens module is disposed on a transmission path of the image beam, and is configured to project the image beam out of the projection device.

In order to achieve one, part or all of the above objects or other objects, an embodiment of the present invention provides a focusing method of a projection device. The method includes the following steps: providing a rotary adjustment member to adjust a focal length of the projection lens; controlling a drive module connected to the rotary adjustment member by a controller to drive to rotate the rotary adjustment member, so that a gravity sensor disposed on the rotary adjustment member rotates synchronously with the rotary adjustment member, and the gravity sensor provides a sensing signal corresponding to the rotary adjustment member; and calculating a rotary angle value of the gravity sensor by the controller according to the sensing signal of the gravity sensor, where the rotary angle value comprises a first rotary angle value and the a second rotary angle value, and the controller is configured to: control the drive module to drive the rotary adjustment member to rotate in a first direction, so that the gravity sensor rotates with the rotary adjustment member from a starting position and stops at a first position, and receive the sensing signal of the gravity sensor which is rotated from the starting position to the first position to obtain the first rotary angle value; control the drive module to drive the rotary adjustment member to rotate in a second direction, so that the gravity sensor rotates with the rotary adjustment member from the first position and stops at a second position, where the first direction is opposite to the second direction, and receive the sensing signal of the gravity sensor which is rotated from the first position to the second position to obtain the second rotary angle value; and obtain a maximum rotary range of the rotary adjustment member according to the first rotary angle value and the second rotary angle value, and obtain a time required for the gravity sensor to rotate for a preset angle value when the drive module drives the rotary adjustment member, thereby adjusting the focal length of the projection lens.

Based on the above, in the lens module, the projection device using the lens module, and the focusing method of the projection device according to an embodiment of the disclosure, the controller of the lens module is configured to: control the drive module to drive the rotary adjustment member to rotate in the first direction, so that the gravity sensor rotates with the rotary adjustment member from the starting position and stops at the first position; and controls the drive module to drive the rotary adjustment member to rotate in the second direction, so that the gravity sensor rotates with the rotary adjustment member from the first position and stops at the second position to obtain the first rotary angle value and the second rotary angle value. Next, the controller is further configured to: obtain the maximum rotary range of the rotary adjustment member and the time required for the drive module to drive the rotary adjustment member to rotate for the preset angle value to adjust the focal length of the projection lens according to the first rotary angle value and the second rotary angle value. That is, the controller may obtain the parameters of the maximum rotary range of the rotary adjustment member and the parameters of the time required to rotate the preset angle value to adjust the focal length of the projection lens. Therefore, there is less need to consider a compensation for a backlash caused by gear rotation during the focusing process of the projection lens. Moreover, there is only one set of the gravity sensor in the lens module, so the controller has fewer vector variables compared to the existing technology. Since the configuration of one set of the gravity sensor is reduced, the overall volume may be reduced, and the cost is lower.

Other objectives, features, and advantages of the present invention will be further understood from the further technological features disclosed by the embodiments of the present invention where there are shown and described preferred embodiments of this invention, simply by way of illustration of modes best suited to carry out the invention.

### BRIEF DESCRIPTION OF THE DRAWINGS

FIG. 1 is a schematic diagram of a projection device according to an embodiment of the disclosure.

FIG. 2 is a schematic diagram of a projection lens, a rotary adjustment member, and a gravity sensor of a lens module in FIG. 1.

FIG. 3A is a schematic diagram of a first shaft, a second shaft, and a third shaft of the gravity sensor of a projection device in FIG. 2 according to the disclosure.

FIG. 3B is a schematic diagram of the angle changes of the first shaft and the second shaft of the gravity sensor of the projection device in FIG. 2 according to the disclosure.

FIG. 3C is another schematic diagram of the angle changes of the first shaft and the second shaft of the gravity sensor of the projection device in FIG. 2 according to the disclosure.

FIG. 3D is another schematic diagram of the angle changes of the first shaft and the second shaft of the gravity sensor of the projection device in FIG. 2 according to the disclosure.

FIG. 4 is a flow chart of a focusing method of a projection device according to an embodiment of the disclosure.

FIG. 5 is a flow chart of obtaining a first rotary angle value, a second rotary angle value, and a time required for a rotary adjustment member to rotate for a preset angle value in a focusing method of a projection device according to an embodiment of the disclosure, thereby adjusting a focal length of a projection lens.

FIG. 6 is a flow chart of obtaining the first rotary angle value in FIG. 5.

FIG. 7 is a flow chart of obtaining the second rotary angle value in FIG. 5.

FIG. 8 is a flowchart of obtaining the time required for the rotary adjustment member to rotate for the preset angle value in FIG. 5.

FIG. 9 is a flow chart of adjusting the focal length of the projection lens in FIG. 5.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

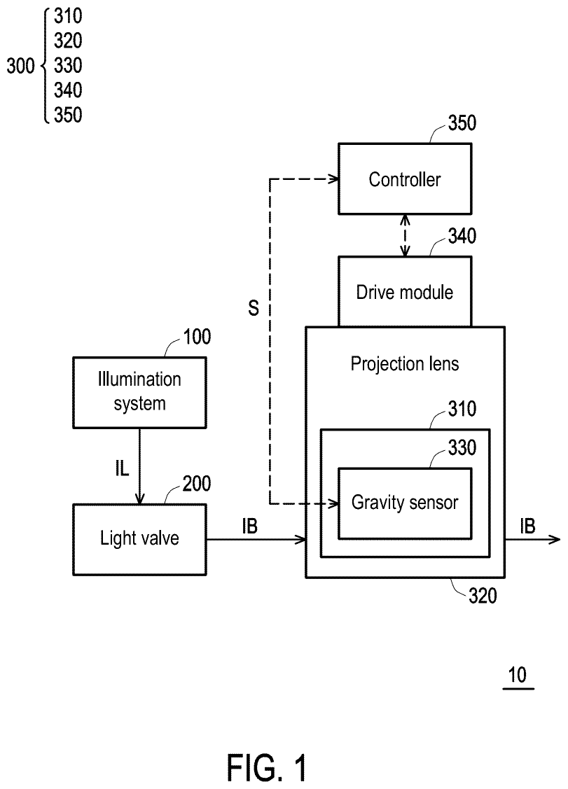

FIG. 1 is a schematic diagram of a projection device according to an embodiment of the disclosure. Referring to FIG. 1, an embodiment of the disclosure provides a projection device 10. The projection device 10 includes an illumination system 100, a light valve 200, and a lens module 300.

In this embodiment, the illumination system 100 is configured to provide an illumination beam IL. The illumination system 100 may be composed of a light source, a wavelength conversion element, a light homogenizing element, a filter element, a light guiding element, and other elements, or the illumination system 100 may be composed of a multi-color light source, a light transmitting element (such as a reflective element or lens), a light splitting element, a light combining element, and other elements to provide beams with different wavelengths as the source of the illumination beam IL. The light source may include one or multiple light emitting elements, where the light emitting elements are light emitting diodes (LED) or/and laser diodes (LD).

In this embodiment, the light valve 200 is disposed on a transmission path of the illumination beam IL, and is configured to convert the illumination beam IL into an image beam IB. The light valve 200 is, for example, a spatial light modulator such as a digital micro-mirror device (DMD), a liquid-crystal-on-silicon panel (LCOS Panel), or a liquid crystal panel.

In addition, a projection lens 320 of the lens module 300 is disposed on a transmission path of the image beam IB, and is configured to project the image beam IB out of the projection device 10. The projection lens 320 is, for example, one optical lens or a combination of multiple optical lenses with a diopter. The disclosure does not limit the projection lens 320 to a certain type or form.

Specifically, the lens module 300 of this embodiment includes the projection lens 320, a rotary adjustment member 310, a gravity sensor 330, a drive module 340, and a controller 350. The rotary adjustment member 310 is, for example, a rotary focusing ring. The drive module 340 is, for example, an element configured to drive the rotary adjustment member 310 to rotate, such as a motor and a stepper motor, but the disclosure is not limited thereto.

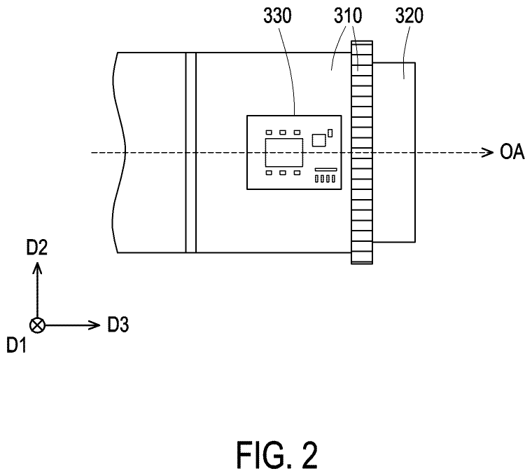

In this embodiment, the rotary adjustment member 310 is connected to the projection lens 320, and is adapted to be rotated to adjust a focal length of the projection lens 320. That is, when the rotary adjustment member 310 is rotated, the distance between the lenses of the projection lens 320 along an optical axis OA (referring to FIG. 2) is changed, so that the focal length of the projection lens 320 is adjusted. The gravity sensor 330 is disposed on the rotary adjustment member 310, is adapted to rotate synchronously with the rotary adjustment member 310, and is configured to provide a sensing signal S corresponding to the rotary adjustment member 310.

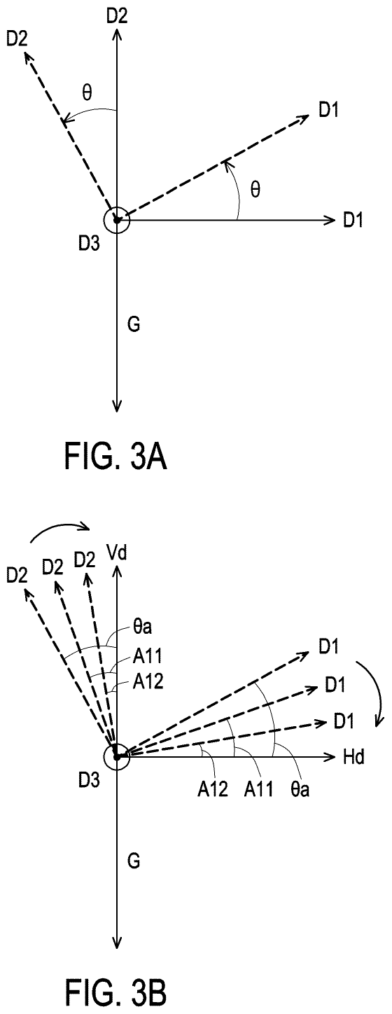

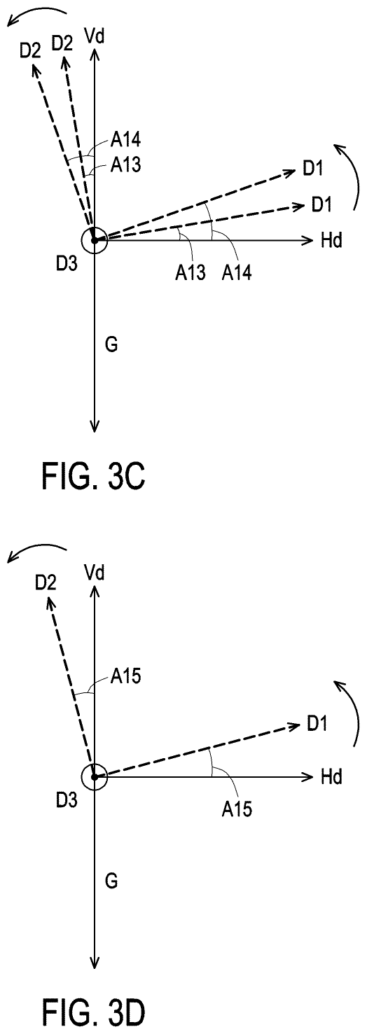

FIG. 2 is a schematic diagram of a projection lens, a rotary adjustment member, and a gravity sensor of a lens module in FIG. 1. FIG. 3A is a schematic diagram of a first shaft, a second shaft, and a third shaft of the gravity sensor of a projection device in FIG. 2 according to the disclosure. Referring to FIG. 2 and FIG. 3A, in this embodiment, the gravity sensor 330 has a first shaft D1, a second shaft D2, and a third shaft D3 which are perpendicular to each other. The gravity sensor 330 is adapted to output a first sensing signal of the first shaft D1 and a second sensing signal of the second shaft D2. The sensing signal S of the gravity sensor 330 includes the first sensing signal of the first shaft D1 and the second sensing signal of the second shaft D2. When the gravity sensor 330 and the rotary adjustment member 310 rotate synchronously, the direction of the third shaft D3 is not changed as the rotary adjustment member 310 rotates.

For example, as shown in FIG. 2, the third shaft D3 may be parallel to the optical axis OA of the projection lens 320, but the disclosure is not limited thereto. Therefore, when the rotary adjustment member 310 rotates, the direction of the third shaft D3 is not changed accordingly. Alternatively, as shown in FIG. 3A, when the rotary adjustment member 310 rotates, the directions of the first shaft D1 and the second shaft D2 relative to a gravity direction G are changed, but the direction of the third shaft D3 is not changed. In FIG. 3A, θ may be calculated as:

$$θ = {tan}^{- 1} ( \frac{A 1}{A 2} ) \times \frac{180}{π} ,$$

where θ is a rotary angle value, A1 is the first sensing signal corresponding to the first shaft D1, and A2 is the second sensing signal corresponding to the second shaft D2.

Referring to FIG. 1 again, in this embodiment, the controller 350 is electrically connected to the drive module 340 and the gravity sensor 330, and is configured to control the drive module 340 and receive the sensing signal S from the gravity sensor 330. The controller 350 includes, for example, a central processing unit (CPU), a microprocessor, a digital signal processor (DSP), a programmable controller, a programmable logic device (PLD), other similar devices, or a combination thereof, and the disclosure is not limited thereto. In addition, in an embodiment, each function of the controller 350 may be implemented as multiple program codes. These codes are stored in a memory unit, and are executed by the controller 350. Alternatively, in an embodiment, each function of the controller 350 may be implemented as one or multiple circuits.

The disclosure does not limit the implementation of each function of the controller 350 by using software or hardware.

In this embodiment, the drive module 340 is connected to the rotary adjustment member 310. The drive module 340 is adapted to drive the rotary adjustment member 310 to rotate under the control of the controller 350. The controller 350 calculates the rotary angle value of the gravity sensor 330 according to the sensing signal S of the gravity sensor 330. The rotary angle value includes a first rotary angle value and a second rotary angle value. The first rotary angle value is a maximum angle value at which the corresponding rotary adjustment member 310 may be rotated in a first direction from a starting position, and the second rotary angle value is a maximum angle value at which the corresponding rotary adjustment member 310 may be rotated in a second direction. The starting position is, for example, a current position of the gravity sensor 330 after the projection device 10 is turned on. The first direction is opposite to the second direction. For example, the first direction and the second direction may be counterclockwise and clockwise or clockwise and counterclockwise respectively. The rotary adjustment member 310 rotates counterclockwise and clockwise, for example, with the optical axis OA of the projection lens 320 as a rotary shaft center. FIG. 3B is a schematic diagram of the angle changes of the first shaft and the second shaft of the gravity sensor of the projection device in FIG. 2 according to the disclosure. Referring to FIG. 3B in conjunction with FIG. 1 and FIG. 2 of the disclosure, for example, the starting position of the gravity sensor 330 is a starting angle θa (the current angle value of the current position) of the first shaft D1 relative to a horizontal direction Hd or the second shaft D2 relative to an anti-gravity direction Vd, where the current position of the gravity sensor 330 may not be parallel to the horizontal direction Hd (not 0 degrees). The starting angle value θa may be, for example, the angle value of 20 degrees of the first shaft D1 relative to the horizontal direction Hd. The anti-gravity direction Vd is parallel and opposite to the gravity direction G. In the following description, since the angle value of the first shaft D1 of the gravity sensor 330 relative to the horizontal direction Hd is the same as the angle value of the second shaft D2 relative to the anti-gravity direction Vd, the angle value of the first shaft D1 of the gravity sensor 330 relative to the horizontal direction Hd is used as the main description.

In this embodiment, the controller 350 is configured to control the drive module 340 to drive the rotary adjustment member 310 to rotate in the first direction, so that the gravity sensor 330 rotates with the rotary adjustment member 310 from the starting position and stops at the first position. Therefore, the controller 350 receives the sensing signal S of the gravity sensor 330 rotated from the starting position to the first position to obtain the first rotary angle value. The controller 350 is further configured to control the drive module 340 to drive the rotary adjustment member 310 to rotate in the second direction, so that the gravity sensor 330 rotates with the rotary adjustment member 310 from the first position and stops at the second position. Therefore, the controller 350 receives the sensing signal S of the gravity sensor 330 rotated from the first position to the second position to obtain the second rotary angle value.

In this embodiment, the controller 350 is further configured to obtain a maximum rotary range of the rotary adjustment member 310 according to the first rotary angle value and the second rotary angle value, and obtain a time required for the gravity sensor 330 to rotate for a preset angle value when the drive module 340 drives the rotary adjustment member 310 to rotate. That is, when the drive module 340 drives the rotary adjustment member 310 to rotate, the gravity sensor 330 continues rotating in the first direction from the starting position and stops at the first position, and when the drive module 340 drives the rotary adjustment member 310 to rotate, the gravity sensor 330 continues rotating in the second direction from the first position and stops at the second position. Therefore, the range between the first position and the second position defines the maximum rotary range of the rotary adjustment member 310. The gravity sensor 330 is stopped at the first position and the second position, which means that even if the drive module 340 continues operating, the rotary adjustment member 310 may not continue rotating. The controller 350 is further configured to adjust the focal length of the projection lens 320 according to the maximum rotary range and the time required for the gravity sensor 330 to rotate for the preset angle value.

The process of the controller 350 obtaining the first rotary angle value is described below with reference to FIG. 3B. In this embodiment, the controller 350 is configured to control the drive module 340 to drive the rotary adjustment member 310 to rotate in the first direction for a first time unit, and receive the sensing signal S of the gravity sensor 330 to obtain a first angle value A11 after the first time unit arrives. As shown in FIG. 3B, the first angle value A11 is, for example, the angle value of the first shaft D1 relative to the horizontal direction Hd after the gravity sensor 330 rotates for the first time unit. The controller 350 is further configured to control the drive module 340 to drive the rotary adjustment member 310 to continue rotating in the first direction for the first time unit, and receive the sensing signal S of the gravity sensor 330 to obtain a second angle value A12 after the first time unit arrives. The second angle value A12 is the angle value of the first shaft D1 relative to the horizontal direction Hd after the gravity sensor 330 continues to rotate for the first time unit from the position of the first angle value A11. That is, the second angle value A12 is the angle value of the first shaft D1 relative to the horizontal direction Hd after the gravity sensor 330 rotates in the first direction for two first time units from the starting position. The controller 350 is further configured to: determine whether the second angle value is equal to the first angle value, set the first angle value as a first target angle value if a determination that the second angle value is equal to the first angle value is yes, and execute target times: controlling the drive module 340 again to drive the rotary adjustment member 310 to rotate for the first time unit, receiving the sensing signal S of the gravity sensor 330 to obtain the second angle value after the first time unit arrives, and determining whether the second angle value of the gravity sensor 330 is equal to the first target angle value; set the second angle value as the first target angle value (that is, the second angle value is set as the first angle value after replacing the first angle value) if the determination that the second angle value is equal to the first angle value is no, and re-execute the aforementioned step of rotating the rotary adjustment member 310: receiving the sensing signal S of the gravity sensor 330 to obtain the updated second angle value, and determining whether the updated second angle value is equal to the first target angle value (if the second angle value is set as the first angle value after replacing the first angle value, then the controller 350 determines whether the second angle value is equal to the first angle value). If the second angle value obtained by the controller 350 is equal to the first target angle value after the controller 350 executes the target times, then the first target angle value is determined to be the first rotary angle value of the gravity sensor 330 at the first position.

For example, the starting position of the gravity sensor 330 is an angle value of 20 degrees relative to the horizontal direction Hd (for example, θa in FIG. 3B). The first time unit is set to 1.0 second, and the execution of target times is set to 3 times (the target times are set on the projector in advance). First, the rotary adjustment member 310 is driven by the drive module 340 to rotate in the first direction (an arrow rotary direction in FIG. 3B) for 1.0 second, and the first angle value is obtained as an angle value of 15 degrees (for example, A11 in FIG. 3B) of the first shaft D1 of the gravity sensor 330 relative to the horizontal direction Hd. Next, the rotary adjustment member 310 is driven to rotate in the first direction for 1.0 second, and the second angle value is obtained as an angle value of 10 degrees (for example, A12 in FIG. 3B) of the first shaft D1 of the gravity sensor 330 relative to the horizontal direction Hd. Since the second angle value A12 is not equal to the first angle value A11, the first target angle value is set as 10 degrees (the second angle value A12), and then the rotary adjustment member 310 is driven to continue rotating in the first direction for 1.0 second to obtain the updated second angle value. The updated second angle value is, for example, an angle value of 5 degrees (not shown in the figure because of analogy) of the first shaft D1 of the gravity sensor 330 relative to the horizontal direction Hd. If the aforementioned process continues running until the execution times that the second angle value is equal to the first target angle value reaches 3 times (for example, the execution times of being equal to the angle value of 5 degrees reach 3 times), then the controller 350 obtains the first rotary angle value, that is, the first target angle value is the first rotary angle value, and obtains the angle value corresponding to the first position as the angle value of 5 degrees of the first shaft D1 of the gravity sensor 330 relative to the horizontal direction Hd.

FIG. 3C is another schematic diagram of the angle changes of the first shaft and the second shaft of the gravity sensor of the projection device in FIG. 2 according to the disclosure. The process of the controller 350 obtaining the second rotary angle value is described below with reference to FIG. 3C.

In this embodiment, after the controller 350 calculates the first rotary angle value of the gravity sensor 330 at the first position, the controller 350 is configured to control the drive module 340 to drive the rotary adjustment member 310 to rotate in the second direction for a second time unit, and receive the sensing signal S of the gravity sensor 330 to obtain a third angle value A13 after the second time unit arrives. As shown in FIG. 3C, the third angle value A13 is the angle value of the first shaft D1 of the gravity sensor 330 relative to the horizontal direction Hd. The controller 350 is further configured to control the drive module 340 to drive the rotary adjustment member 310 to continue rotating in the second direction for the second time unit, and receive the sensing signal S of the gravity sensor 330 to obtain a fourth angle value A14 after the second time unit arrives. The fourth angle value A14 is the angle value of the first shaft D1 relative to the horizontal direction Hd after the gravity sensor 330 continues rotating for the second time unit from the position of the third angle value A13. The controller 350 is further configured to: determine whether the fourth angle value is equal to the third angle value, set the third angle value as the second target angle value if a determination that the fourth angle value is equal to the third angle value is yes, and execute the target times: controlling the drive module 340 again to drive the rotary adjustment member 310 to rotate for the second time unit, receiving the sensing signal S of the gravity sensor 330 to obtain the fourth angle value A14 after the second time unit arrives, and determining whether the fourth angle value of the gravity sensor 330 is equal to the second target angle value; set the fourth angle value as the second target angle value (that is, the four angle value is set as the third angle value after replacing the third angle value) if the determination that the fourth angle value is equal to the third angle value is no, and re-execute the aforementioned step of rotating the rotary adjustment member 310: receiving the sense signal S of the gravity sensor 330 to obtain the updated fourth angle value, and determining whether the updated fourth angle value of the gravity sensor 330 is equal to the second target angle value (if the fourth angle value is set as the third angle value after replacing the third angle value, then the controller 350 determines whether the fourth angle value is equal to the third angle value). The fourth angle value obtained by the controller 350 is equal to the second target angle value after the controller 350 executes the target times, then the second target angle value is determined to be the second rotary angle value of the gravity sensor 330 at the second position.

For example, the second time unit is set to 1.0 second, and the execution of target times is set to 3 times (the target times are set on the projector in advance). The drive module 340 is first executed to drive the rotary adjustment member 310 to rotate in the first direction to obtain the first rotary angle value, and then the step of rotating in the second direction to obtain the second rotary angle value is executed, so the gravity sensor 330 starts from the first position (the first position corresponds to the angle value of 5 degrees according to the aforementioned example), drives the rotary adjustment member 310 to rotate in the second direction (an arrow rotary direction in FIG. 3C) for 1.0 second (rotating for 1.0 second and moving 5 degrees according to the aforementioned example) to obtain the third angle value. The third angle value is the angle value of 10 degrees (for example, A13 in FIG. 3C) of the first shaft D1 of the gravity sensor 330 relative to the horizontal direction Hd. Next, the rotary adjustment member 310 is driven to rotate in the second direction for 1.0 second to obtain a fourth angle value of 15 degrees relative to the horizontal direction Hd (for example, A14 in FIG. 3C). Since the fourth angle value A14 is not equal to the third angle value A13, the second target angle value is set as 15 degrees (the fourth angle value A14), and the rotary adjustment member 310 is driven to continue rotating in the second direction for 1.0 second to obtain the updated fourth angle value. The updated angle value is, for example, 20 degrees relative to the horizontal direction Hd (not shown in the figure because of analogy). If the aforementioned process continues running until the execution times that the fourth angle value is equal to the third angle value reach 3 times, then the controller 350 obtains the second rotary angle value, that is, the second target angle value is the second rotary angle value, and obtains the angle value corresponding to the second position as the angle value of 65 degrees of the first shaft D1 of the gravity sensor 330 relative to the horizontal direction Hd, for example.

Moreover, in the process of the controller 350 obtaining the second rotary angle value, the controller 350 may further calculate and obtain the time required for the gravity sensor 330 to rotate for 1 degree. Referring to FIG. 3D, which is another schematic diagram of the angle changes of the first shaft and the second shaft of the gravity sensor of the projection device in FIG. 2 according to the disclosure. The process is described below with reference to FIG. 3D.

In this embodiment, the controller 350 controls the drive module 340 to drive the rotary adjustment member 310 to rotate in the second direction for the second time unit, and before the second time unit arrives, the controller 350 is configured to: control the drive module 340 first to drive the rotary adjustment member 310 rotates in the second direction for the third time unit, and receives the sensing signal S of the gravity sensor 330 to obtain a fifth angle value A15. As shown in FIG. 3D, the fifth angle value A15 is, for example, the first shaft D1 of the gravity sensor 330 relative to the horizontal direction Hd, where the third time unit is less than or equal to the second time unit. The controller 350 is further configured to calculate the time required for the gravity sensor 330 to rotate for 1 degree according to the third time unit and a fifth angle value. The time required for the gravity sensor 330 to rotate for 1 degree is t, t=t3/||θ1|−|θ5||, where θ1 is the first rotary angle value of the gravity sensor 330 at the first position, θ5 is the fifth angle value A15, and t3 is the third time unit.

According to the aforementioned example, the first position of the gravity sensor 330 is 5 degrees relative to the horizontal direction Hd. The second time unit is, for example, set to 1.0 second, and the third time unit is also set to 1.0 second, for example. Starting from the first position, the controller 350 first controls the drive module 340 to drive the rotary adjustment member 310 to rotate in the second direction for 1.0 second to obtain the fifth angle value from the first position to the current position. The fifth angle value A15 is the angle value of 10 degrees (for example, A15 in FIG. 3D) of the first shaft D1 relative to the horizontal direction Hd. Therefore, the time required for the gravity sensor 330 to rotate for 1 degree is t=1.0/||5|−|10||=0.2 seconds/degree.

The process of the controller 350 controlling the drive module 340 to adjust the focal length of projection lens 310 is described below.

In this embodiment, the controller 350 controls the drive module 340 to drive the rotary adjustment member 310 to rotate to adjust the focal length of the projection lens 320. The controller 350 is configured to confirm the angle value of the target position, and obtain the current angle value of the gravity sensor 330, where the angle value of the target position and the current angle value of the gravity sensor 330 are, for example, the angle values of the first shaft D1 relative to the horizontal direction Hd and/or the angle values of the second shaft D2 relative to the vertical anti-gravity direction Vd. The controller 350 is further configured to: determine whether the difference between the angle value of the target position and the current angle value falls within a preset range; complete the adjustment of the focal length of the projection lens 230 if a determination that the difference between the angle value of the target position and the current angle value falls within the preset range is yes; control the drive module 340 to drive the rotary adjustment member 310 to rotate in the first direction or the second direction according to the difference if the determination that the difference between the angle value of the target position and the current angle value falls within the preset range is no; control the drive module 340 to drive the rotary adjustment member 310 to rotate for a fourth time unit according to the time t required for the gravity sensor 330 to rotate for 1 degree; and re-execute the aforementioned step: receiving the sensing signal S of the gravity sensor 330 to obtain the current angle value, and determining whether the difference falls within the preset range.

Based on the foregoing description, examples are also given with reference to FIG. 3B to FIG. 3D. Since the time t required for the gravity sensor 330 to rotate for 1 degree is 0.2 seconds, that is, the drive module 340 drives the rotary adjustment member 310 at 0.2 seconds/degree to cause the gravity sensor 330 to rotate with the rotary adjustment member 310. It is assumed that the angle value of the target position relative to the horizontal direction Hd is 5 degrees, the current angle value of the gravity sensor 330 is the angle value of 10 degrees of the first shaft D1 relative to the horizontal direction Hd, and the preset range is, for example, ±0.25 degrees. When the rotary adjustment member 310 is driven to rotate in the first direction for 1 degree, the controller 350 determines whether the difference between the updated current angle value (9 degrees) and the angle value (5 degrees) of the target position falls within ±0.25 degrees. If the difference is not within ±0.25 degrees, then the rotary adjustment member 310 continues to be driven to rotate until the difference is within ±0.25 degrees. The aforementioned description of rotating the preset angle value may be, for example, rotating for 1 degree, and the time required to rotate the preset angle value may be the fourth time unit, that is, 0.2 seconds.

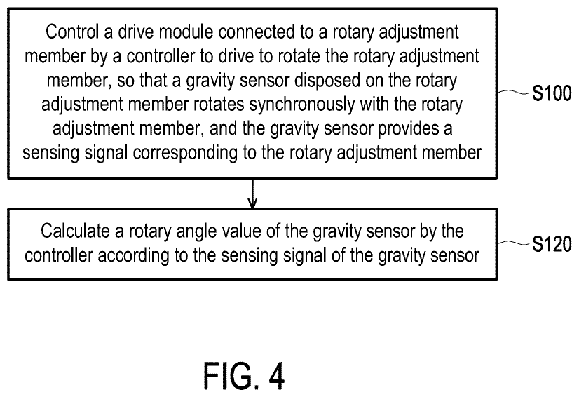

FIG. 4 is a flow chart of a focusing method of a projection device according to an embodiment of the disclosure. Referring to FIG. 4, an embodiment of the disclosure provides a focusing method of the projection device 10, which includes the following steps. The rotary adjustment member 310 is provided to adjust the focal length of the projection lens 320. In Step S100, the controller 350 controls the drive module 340 connected to the rotary adjustment member 310 to drive to rotate the rotary adjustment member 310, so that the gravity sensor 330 disposed on the rotary adjustment member 310 rotates synchronously with the rotary adjustment member 310, and the gravity sensor 330 provides the sensing signal S corresponding to the rotary adjustment member 310. In Step S120, the controller 350 calculates the rotary angle value of the gravity sensor 330 according to the sensing signal S of the gravity sensor 330.

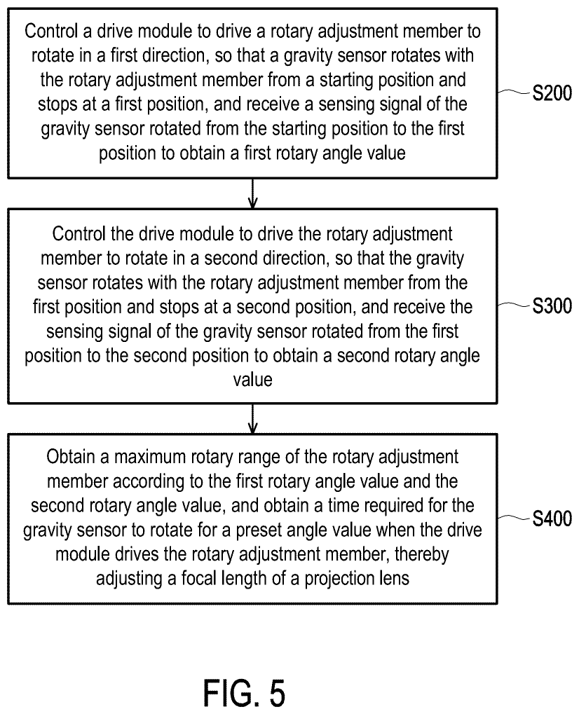

FIG. 5 is a flow chart of obtaining a first rotary angle value, a second rotary angle value, and the time required for a rotary adjustment member to rotate for a preset angle value in a focusing method of a projection device according to an embodiment of the disclosure, thereby adjusting a focal length of a projection lens. Referring to FIG. 5, in Step S200, the controller 350 is configured to control the drive module 340 to drive the rotary adjustment member 310 to rotate in the first direction, so that the gravity sensor 330 rotates with the rotary adjustment member 310 from the starting position and stops at the first position, and receive the sensing signal S of the gravity sensor 330 which is rotated from the starting position to the first position to obtain the first rotary angle value. In Step 300, the controller 350 is configured to control the drive module 340 to drive the rotary adjustment member 310 to rotate in the second direction, so that the gravity sensor 330 rotates with the rotary adjustment member 310 from the first position and stops at the second position, and receive the sensing signal S of the gravity sensor 330 which is rotated from the first position to the second position to obtain the second rotary angle value. In Step S400, the controller 350 is configured to obtain the maximum rotary range of the rotary adjustment member 310 according to the first rotary angle value and the second rotary angle value, and obtain the time required for the gravity sensor 330 to rotate for the preset angle value when the drive module 340 drives the rotary adjustment member 310, thereby adjusting the focal length of the projection lens 320.

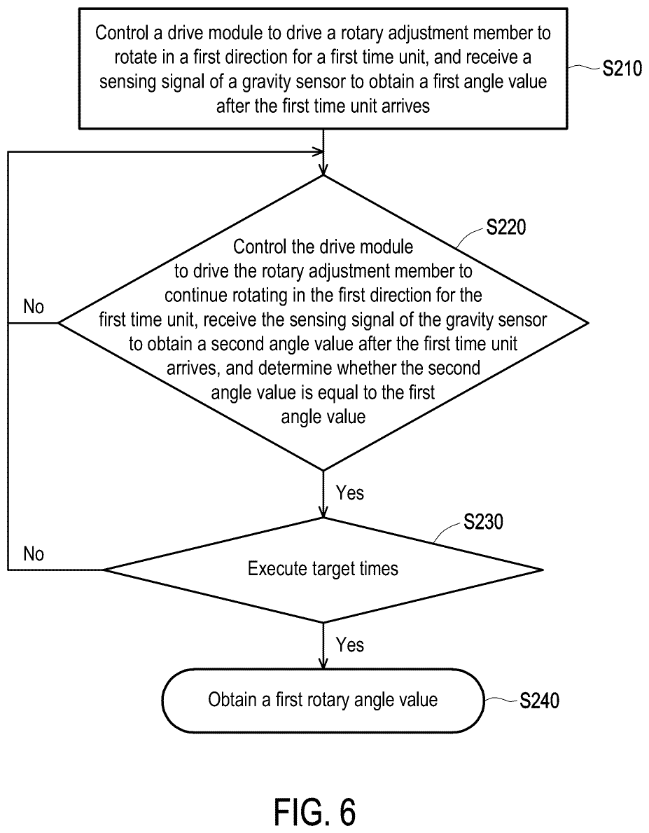

FIG. 6 is a flow chart of obtaining the first rotary angle value in FIG. 5. Referring to FIG. 6, in this embodiment, the aforementioned Step S200 includes the following steps. In Step S210, the controller 350 is further configured to control the drive module 340 to drive the rotary adjustment member 310 to rotate in the first direction for the first time unit, receive the sensing signal S of the gravity sensor 330 to obtain the first angle value A11 after the first time unit arrives. In Step S220, the controller 350 is further configured to control the drive module 340 to drive the rotary adjustment member 310 to continue rotating in the first direction for the first time unit, receive the sensing signal S of the gravity sensor 330 to obtain the second angle value A12 after the first time unit arrives, and determines whether the second angle value A12 is equal to the first angle value A11. If the determination that second angle value A12 is equal to the first angle value A11 is yes, the controller 350 sets the first angle value A11 as the first target angle value, enters Step S230, and executes the target times. The controller 350 again controls the drive module 340 to drive the rotary adjustment member 310 to rotate for the first time unit, receives the sensing signal S of the gravity sensor 330 to obtain the second angle value after the first time unit arrives, and determines whether the second angle value of the gravity sensor 330 is equal to the first target angle value. If the determination that second angle value A12 is equal to the first angle value A11 is no, the controller 350 sets the second angle value as the first target angle value (that is, the second angle value is set as the first angle value after replacing the first angle value), re-executes the aforementioned step of receiving the sensing signal S from the gravity sensor 330 to obtain the updated second angle value, and determining whether the updated second angle value of the gravity sensor 330 is equal to the first target angle value (if the second angle value is set as the first angle value after replacing the first angle value, then the controller 350 determines whether the second angle value is equal to the first angle value). In Step S240, the second angle value obtained by the controller 350 is equal to the first target angle value after the controller 350 executes the target times, then the first target angle value is determined to be the first rotary angle value of the gravity sensor 330 at the first position.

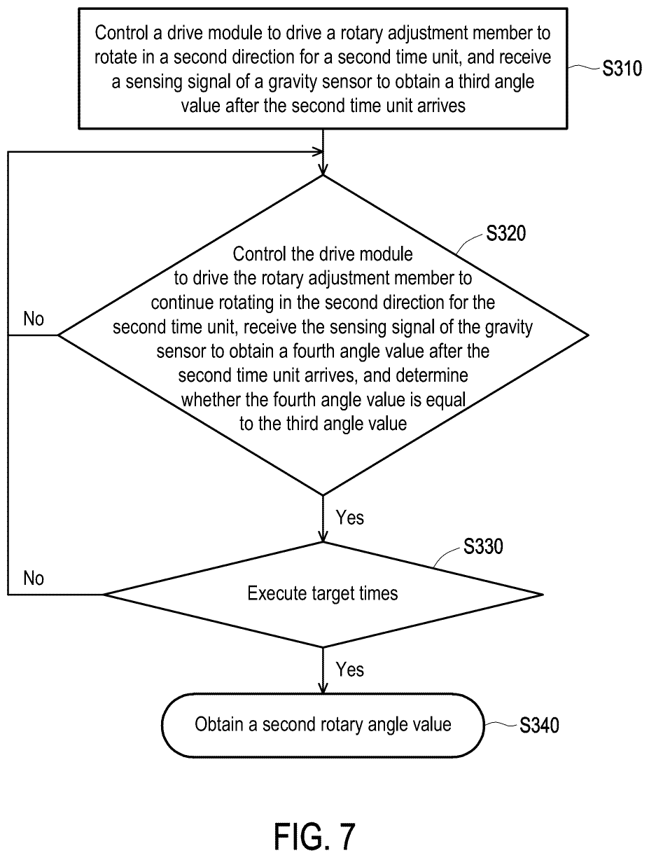

FIG. 7 is a flow chart of obtaining the second rotary angle value in FIG. 5. Referring to FIG. 7, in this embodiment, the aforementioned Step S300 includes the following steps. After obtaining the first rotary angle value of the gravity sensor 330 at the first position, in Step S310, the controller 350 is configured to control the drive module 340 to drive the rotary adjustment member 310 to rotate in the second direction for the second time unit, receive the sensing signal S of the gravity sensor 330 to obtain the third angle value A13 after the second time unit arrives. In Step S320, the controller 350 is configured to control the drive module 340 to drive the rotary adjustment member 310 to continue rotating in the second direction for the second time unit, receive the sensing signal S of the gravity sensor 330 to obtain the fourth angle value A14 after the second time unit arrives, and determine whether the fourth angle value A14 is equal to the third angle value A13. If the determination that the fourth angle value A14 is equal to the third angle value A13 is yes, the controller 350 sets the third angle value A13 as the second target angle value, enters Step S330, and executes the target times. The controller 350 again controls the drive module 340 to drive the rotary adjustment member 310 to rotate for the second time unit, receives the sensing signal S of the gravity sensor 330 to obtains the fourth angle value A14 after the second time unit arrives, and determines whether the fourth angle value A14 of the gravity sensor 330 is equal to the second target angle value. If the determination the fourth angle value A14 is equal to the third angle value A13 is no, the controller 350 sets the fourth angle value as the second target angle value (that is, the fourth angle value A14 is set as the third angle value A13 after replacing the third angle value A13), re-executes the aforementioned step of receiving the sensing signal S from the gravity sensor 330 to obtain the updated fourth angle value, and determining whether the updated fourth angle value of the gravity sensor 330 is equal to the second target angle value (if the fourth angle value A14 is set as the third angle value A13 after replacing the third angle value, then the controller 350 determines whether the fourth angle value A14 is equal to the third angle value A13). In Step S340, the fourth angle value obtained by the controller 350 is equal to the second target angle value after the controller 350 executes the target times, then the second target angle value is determined to be the second rotary angle value of the gravity sensor 330 at the second position.

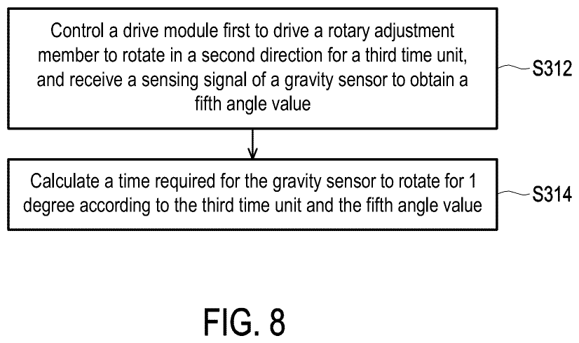

FIG. 8 is a flowchart of obtaining the time required for the rotary adjustment member to rotate a preset angle value in FIG. 5. Referring to FIG. 8, in this embodiment, the aforementioned Step S310 includes the following steps. The controller 350 controls the drive module 340 to drive the rotary adjustment member 310 to rotate in the second direction for the second time unit. Before the second time unit arrives, in Step S312, the controller 350 is configured to control the drive module 340 first to drive the rotary adjustment member 310 to rotate in the second direction for the third time unit, and receive the sensing signal S of the gravity sensor 330 to obtain the fifth angle value A15. In Step S314, the controller 350 is configured to calculate the time required for the gravity sensor 330 to rotate for 1 degree according to the third time unit and the fifth angle value A15.

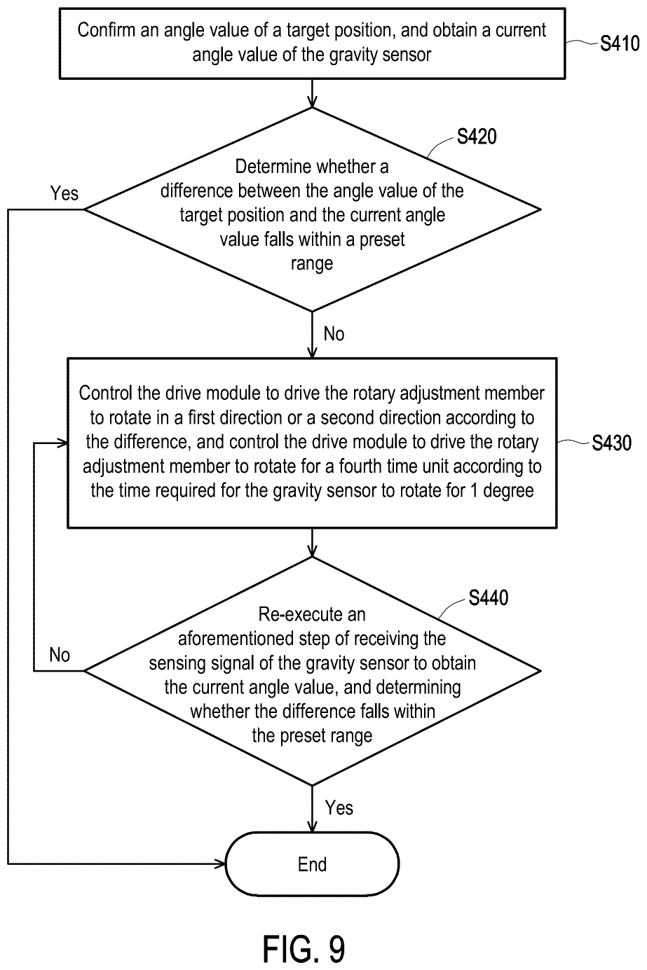

FIG. 9 is a flow chart of adjusting the focal length of the projection lens in FIG. 5. Referring to FIG. 9, in this embodiment, the aforementioned Step S400 includes the following steps. In Step 410, the controller 350 is configured to confirm the angle value of the target position, and obtain the current angle value of the gravity sensor 330. In Step S420, the controller 350 is configured to determine whether the difference between the angle value of the target position and the current angle value falls within the preset range. If the determination that the difference between the angle value of the target position and the current angle value falls within the preset range is yes, the controller 350 completes the adjustment of the focal length of the projection lens 320. If the determination that the difference between the angle value of the target position and the current angle value falls within the preset range is no, in Step S430, the controller 350 controls the drive module 340 to drive the rotary adjustment member 310 to rotate in the first direction or the second direction according to the difference, controls the drive module 340 to drive the rotary adjustment member 310 to rotate for the fourth time unit according to the time required for the gravity sensor 330 to rotate for 1 degree, and re-executes the aforementioned step of receiving the sensing signal S of the gravity sensor 330 to obtain the current angle value, and determining whether the difference falls within the preset range in Step S440.

To sum up, in a lens module, a projection device using the lens module, and a focusing method of a projection device according to an embodiment of the disclosure, the lens module includes a projection lens, a rotary adjustment member, a gravity sensor, a drive module, and a controller. Since the gravity sensor is small and can be easily installed on the rotary adjustment member, the lens module is adaptable for a micro projection device or focusing of the micro projection device. Moreover, the sensing method of the gravity sensor is not light sensing, so the lens module is not interfered by external light sources and dust. In addition, the gravity sensor has high precision and uses digital output to resist noise interference.

Furthermore, in the lens module, the projection device using the lens module, and the focusing method of the projection device according to an embodiment of the disclosure, the controller of the lens module is configured to: control the drive module to drive the rotary adjustment member to rotate in the first direction, so that the gravity sensor rotates with the rotary adjustment member from the starting position and stops at the first position; and controls the drive module to drive the rotary adjustment member to rotate in the second direction, so that the gravity sensor rotates with the rotary adjustment member from the first position and stops at the second position to obtain the first rotary angle value and the second rotary angle value. Next, the controller is further configured to: obtain the maximum rotary range of the rotary adjustment member and the time required for the drive module to drive the rotary adjustment member to rotate for the preset angle value to adjust the focal length of the projection lens according to the first rotary angle value and the second rotary angle value. That is, the controller may obtain the parameters of the maximum rotary range of the rotary adjustment member and the parameters of the time required to rotate the preset angle value to adjust the focal length of the projection lens. Therefore, there is less need to consider a compensation for a backlash caused by gear rotation during the focusing process of the projection lens. Moreover, there is only one set of the gravity sensor in the lens module, so the controller has fewer vector variables compared to the existing technology. Since the configuration of one set of the gravity sensor is reduced, the overall volume may be reduced, and the cost is lower.

The forward description of the preferred embodiments of the invention has been presented for purposes of illustration and description. It is not intended to be exhaustive or to limit the invention to the precise form or to exemplary embodiments disclosed. Accordingly, the forward description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred example embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the Moreover, no element and component in the present disclosure is intended to be dedicated to the public regardless of whether the element or component is explicitly recited in the appended claims.

What is claimed is:

1. A lens module, adaptable for a projection device, wherein the lens module comprises: a projection lens, a rotary adjustment member, a gravity sensor, a drive module, and a controller, wherein:
the rotary adjustment member is connected to the projection lens and is adapted to be rotated to adjust a focal length of the projection lens;
the gravity sensor is disposed on the rotary adjustment member, is adapted to rotate synchronously with the rotary adjustment member, and is configured to provide a sensing signal corresponding to the rotary adjustment member;
the controller is electrically connected to the drive module and the gravity sensor and is configured to control the drive module and receive the sensing signal from the gravity sensor; and
the drive module is connected to the rotary adjustment member and is adapted to drive the rotary adjustment member to rotate under a control of the controller;
wherein the controller calculates a rotary angle value of the gravity sensor according to the sensing signal of the gravity sensor, and the rotary angle value comprises a first rotary angle value and a second rotary angle value;
the controller is configured to:
control the drive module to drive the rotary adjustment member to rotate in a first direction, so that the gravity sensor rotates with the rotary adjustment member from a starting position and stops at a first position;
receive the sensing signal of the gravity sensor which is rotated from the starting position to the first position to obtain the first rotary angle value;
control the drive module to drive the rotary adjustment member to rotate in a second direction, so that the gravity sensor rotates with the rotary adjustment member from the first position and stops at a second position, wherein the first direction is opposite to the second direction;
receive the sensing signal of the gravity sensor which is rotated from the first position to the second position to obtain the second rotary angle value;
obtain a maximum rotary range of the rotary adjustment member according to the first rotary angle value and the second rotary angle value, and obtain a time required for the gravity sensor to rotate for a preset angle value when the drive module drives the rotary adjustment member; and
adjust the focal length of the projection lens according to the maximum rotary range and the time required for the gravity sensor to rotate for the preset angle value.

2. The lens module according to claim 1, wherein the gravity sensor has a first shaft, a second shaft, and a third shaft which are perpendicular to each other, and the gravity sensor is adapted to output a first sensing signal of the first shaft and a second sensing signal of the second shaft, wherein:
the sensing signal of the gravity sensor comprises the first sensing signal of the first shaft and the second sensing signal of the second shaft; and
when the gravity sensor rotates synchronously with the rotary adjustment member, a direction of the third shaft is not changed as the rotary adjustment member rotates.

3. The lens module according to claim 2, wherein:
$$θ = {tan}^{- 1} ( \frac{A 1}{A 2} ) \times \frac{180}{π} ,$$
wherein θ is the rotary angle value, A1 is the first sensing signal of the first shaft, and A2 is the second sensing signal of the second shaft.

4. The lens module according to claim 1, wherein the controller is configured to:
control the drive module to drive the rotary adjustment member to rotate in the first direction for a first time unit, and receive the sensing signal of the gravity sensor to obtain a first angle value after the first time unit arrives;
control the drive module to drive the rotary adjustment member to continue rotating in the first direction for the first time unit, and receive the sensing signal of the gravity sensor to obtain a second angle value after the first time unit arrives; and
determine whether the second angle value is equal to the first angle value,
if a determination that the second angle value is equal to the first angle value is yes, set the first angle value as a first target angle value, and execute target times: controlling the drive module again to drive the rotary adjustment member to rotate for the first time unit, receiving the sensing signal of the gravity sensor to obtain the second angle value after the first time unit arrives, and determining whether the second angle value of the gravity sensor is equal to the first target angle value; and
if the determination that the second angle value is equal to the first angle value is no, set the second angle value as the first target angle value, and re-execute the aforementioned step of receiving the sensing signal of the gravity sensor to obtain an updated second angle value, and determining whether the updated second angle value of the gravity sensor is equal to the first target angle value,
wherein the second angle value obtained by the controller is equal to the first target angle value after the controller executes the target times, and the first target angle value is determined to be the first rotary angle value of the gravity sensor at the first position.

5. The lens module according to claim 4, wherein after the controller calculates the first rotary angle value of the gravity sensor at the first position, the controller is configured to:
control the drive module to drive the rotary adjustment member to rotate in the second direction for a second time unit, and receive the sensing signal of the gravity sensor to obtain a third angle value after the second time unit arrives;
control the drive module to drive the rotary adjustment member to continue rotating in the second direction for the second time unit, and receive the sensing signal of the gravity sensor to obtain a fourth angle value after the second time unit arrives; and
determine whether the fourth angle value is equal to the third angle value,
if a determination that the fourth angle value is equal to the third angle value is yes, set the third angle value as a second target angle value, and execute the target times: controlling the drive module again to drive the rotary adjustment member to rotate for the second time unit, receiving the sensing signal of the gravity sensor to obtain the fourth angle value after the second time unit arrives, and determining whether the fourth angle value of the gravity sensor is equal to the second target angle value; and
if the determination that the fourth angle value is equal to the third angle value is no, set the fourth angle value as the second target angle value, and re-execute the aforementioned step of receiving the sensing signal of the gravity sensor to obtain an updated fourth angle value, and determining whether the updated fourth angle value of the gravity sensor is equal to the second target angle value,
wherein the fourth angle value obtained by the controller is equal to the second target angle value after the controller executes the target times, and the second target angle value is determined to be the second rotary angle value of the gravity sensor at the second position.

6. The lens module according to claim 5, wherein the controller controls the drive module to drive the rotary adjustment member to rotate in the second direction for the second time unit, and before the second time unit arrives, the controller is configured to:
control the drive module first to drive the rotary adjustment member to rotate in the second direction for a third time unit, and receive the sensing signal of the gravity sensor to obtain a fifth angle value, wherein the third time unit is less than or equal to the second time unit; and
calculate the time required for the gravity sensor to rotate for one degree according to the third time unit and the fifth angle value,
wherein the time required for the gravity sensor to rotate for one degree is t=t3/||θ1|−|θ5||, wherein θ1 is the first rotary angle value of the gravity sensor at the first position, θ5 is the fifth angle value, and t3 is the third time unit.

7. The lens module according to claim 1, wherein the controller controls the drive module to drive the rotary adjustment member to rotate to adjust the focal length of the projection lens, and the controller is configured to:
confirm an angle value of a target position and obtain a current angle value of the gravity sensor; and
determine whether a difference between the angle value of the target position and the current angle value falls within a preset range,
if a determination that the difference between the angle value of the target position and the current angle value falls within the preset range is yes, complete an adjustment of the focal length of the projection lens; and
if the determination that the difference between the angle value of the target position and the current angle value falls within the preset angle is no, control the drive module to drive the rotary adjustment member to rotate in the first direction or the second direction according to the difference, control the drive module to drive the rotary adjustment member to rotate for a fourth time unit according to the time required for the gravity sensor to rotate for one degree, and re-execute the aforementioned step of receiving the sensing signal of the gravity sensor to obtain the current angle value, and determining whether the difference falls within the preset range.

8. A projection device, comprising an illumination system, a light valve, and the lens module according to claim 1, wherein the illumination system is configured to provide an illumination beam, the light valve is disposed on a transmission path of the illumination beam and is configured to convert the illumination beam into an image beam, and the projection lens of the lens module is disposed on a transmission path of the image beam and is configured to project the image beam out of the projection device.

9. A focusing method of a projection device, comprising:
providing a rotary adjustment member to adjust a focal length of a projection lens;
controlling a drive module connected to the rotary adjustment member by a controller to drive to rotate the rotary adjustment member, so that a gravity sensor disposed on the rotary adjustment member rotates synchronously with the rotary adjustment member, and the gravity sensor provides a sensing signal corresponding to the rotary adjustment member; and
calculating a rotary angle value of the gravity sensor by the controller according to the sensing signal of the gravity sensor, wherein the rotary angle value comprises a first rotary angle value and the a second rotary angle value, and the controller is configured to:
control the drive module to drive the rotary adjustment member by the controller to rotate in a first direction, so that the gravity sensor rotates with the rotary adjustment member from a starting position and stops at a first position, and receive the sensing signal of the gravity sensor which is rotated from the starting position to the first position to obtain the first rotary angle value;
control the drive module to drive the rotary adjustment member to rotate in a second direction, so that the gravity sensor rotates with the rotary adjustment member from the first position and stops at a second position, wherein the first direction is opposite to the second direction, and receive the sensing signal of the gravity sensor which is rotated from the first position to the second position to obtain the second rotary angle value; and
obtain a maximum rotary range of the rotary adjustment member according to the first rotary angle value and the second rotary angle value, and obtain a time required for the gravity sensor to rotate for a preset angle value when the drive module drives the rotary adjustment member, thereby adjusting the focal length of the projection lens.

10. The focusing method of the projection device according to claim 9, wherein the gravity sensor has a first shaft, a second shaft, and a third shaft which are perpendicular to each other, and the gravity sensor is adapted to output a first sensing signal of the first shaft and a second sensing signal of the second shaft, wherein:
the sensing signal of the gravity sensor comprises the first sensing signal of the first shaft and the second sensing signal of the second shaft; and
when the gravity sensor rotates synchronously with the rotary adjustment member, a direction of the third shaft is not changed as the rotary adjustment member rotates.

11. The focusing method of the projection device according to claim 10, wherein:
$$θ = {tan}^{- 1} ( \frac{A 1}{A 2} ) \times \frac{180}{π} ,$$
wherein θ is the rotary angle value, A1 is the first sensing signal of the first shaft, and A2 is the second sensing signal of the second shaft.

12. The focusing method of the projection device according to claim 9, wherein the controller is further configured to:
control the drive module to drive the rotary adjustment member to rotate in the first direction for a first time unit, and receive the sensing signal of the gravity sensor to obtain a first angle value after the first time unit arrives;
control the drive module to drive the rotary adjustment member to continue rotating in the first direction for the first time unit, and receive the sensing signal of the gravity sensor to obtain a second angle value after the first time unit arrives; and
determine whether the second angle value is equal to the first angle value,
if a determination that the second angle value is equal to the first angle value is yes, set the first angle value as a first target angle value, and execute target times: controlling the drive module again to drive the rotary adjustment member to rotate for the first time unit, receiving the sensing signal of the gravity sensor to obtain the second angle value after the first time unit arrives, and determining whether the second angle value of the gravity sensor is equal to the first target angle value; and
if the determination that the second angle value is equal to the first angle value is no, set the second angle value as the first target angle value, and re-execute the aforementioned step of receiving the sensing signal of the gravity sensor to obtain an updated second angle value, and determining whether the updated second angle value of the gravity sensor is equal to the first target angle value,
wherein the second angle value obtained by the controller is equal to the first target angle value after the controller executes the target times, and the first target angle value is determined to be the first rotary angle value of the gravity sensor at the first position.

13. The focusing method of the projection device according to claim 12, wherein after obtaining the first rotary angle value of the gravity sensor at the first position by the controller, the controller is configured to:
control the drive module to drive the rotary adjustment member to rotate in the second direction for a second time unit, and receive the sensing signal of the gravity sensor to obtain a third angle value after the second time unit arrives;
control the drive module to drive the rotary adjustment member to continue rotating in the second direction for the second time unit, and receive the sensing signal of the gravity sensor to obtain a fourth angle value after the second time unit arrives; and
determine whether the fourth angle value is equal to the third angle value,
if a determination that the fourth angle value is equal to the third angle value is yes, set the third angle value as a second target angle value, and execute the target times: controlling the drive module again to drive the rotary adjustment member to rotate for the second time unit, receiving the sensing signal of the gravity sensor to obtain the fourth angle value after the second time unit arrives, and determining whether the fourth angle value of the gravity sensor is equal to the second target angle value; and
if the determination that the fourth angle value is equal to the third angle value is no, set the fourth angle value as the second target angle value, and re-execute the aforementioned step of receiving the sensing signal of the gravity sensor to obtain an updated fourth angle value, and determining whether the updated fourth angle value of the gravity sensor is equal to the second target angle value,
wherein the fourth angle value obtained by the controller is equal to the second target angle value after the controller executes the target times, and the second target angle value is determined to be the second rotary angle value of the gravity sensor at the second position.

14. The focusing method of the projection device according to claim 13, wherein the drive module is controlled by the controller to drive the rotary adjustment member to rotate in the second direction for the second time unit, and before the second time unit arrives, the controller is configured to:
control the drive module first to drive the rotary adjustment member to rotate in the second direction for a third time unit, and receive the sensing signal of the gravity sensor to obtain a fifth angle value, wherein the third time unit is less than or equal to the second time unit; and
calculate the time required for the gravity sensor to rotate for one degree according to the third time unit and the fifth angle value,
wherein the time required for the gravity sensor to rotate for one degree is t=t3/||θ1|−|θ5||, wherein θ1 is the first rotary angle value of the gravity sensor at the first position, θ5 is the fifth angle value, and t3 is the third time unit.

15. The focusing method of the projection device according to claim 9, wherein the drive module is controlled by the controller to drive the rotary adjustment member to rotate to adjust the focal length of the projection lens, and the controller is configured to:
confirm an angle value of a target position, and obtain a current angle value of the gravity sensor; and
determine whether a difference between the angle value of the target position and the current angle value falls within a preset range,
if a determination that the difference between the angle value of the target position and the current angle value falls within the preset range is yes, complete an adjustment of the focal length of the projection lens; and
if the determination that the difference between the angle value of the target position and the current angle value falls within the preset angle is no, control the drive module to drive the rotary adjustment member to rotate in the first direction or the second direction according to the difference, control the drive module to drive the rotary adjustment member to rotate for a fourth time unit according to the time required for the gravity sensor to rotate for one degree, and re-execute the aforementioned step of receiving the sensing signal of the gravity sensor to obtain the current angle value, and determining whether the difference falls within the preset range.
